(19) United States
(12) Patent Application Publication
(10) Pub. No.: US 2006/0222310 A1
(43) Pub. Date: Oct. 5, 2006

(54) Optical fiber fixing member and manufacturing method of the same and optical module and manufacturing method of the same

(75) Inventor: Kazuyoshi Watanabe, Yamanashi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: EUDYNA DEVICES INC., Yamanashi (JP)

(21) Appl. No.: 11/391,358

(22) Filed: Mar. 29, 2006

(30) Foreign Application Priority Data
Mar. 31, 2005 (JP) 2005-104099

(51) Int. Cl. G02B 6/00

(52) U.S. Cl. 385/137

(57) ABSTRACT

An optical fiber fixing member includes holding portions formed by bending portions defined by incisions formed in a metal member and a fixing portion defined by a remaining portion of the metal member except the holding portions. The holding portions sandwich an optical fiber from both sides thereof, and the fixing portion is used to attach the optical fiber fixing member to a support member.

### BACKGROUND OF THE INVENTION

1. Field of the Invention

This invention generally relates to an optical fiber fixing member for use in the optical communications field and manufacturing method of the same and an optical module having the afore-mentioned fixing member and manufacturing method of the same.

2. Description of the Related Art

Conventionally, a fixing member has been used for fixing an optical fiber. The fixing member is used for fixing an optical fiber protecting member to a module. Generally, since the optical fiber is very thin, the optical fiber is not directly attached. The optical fiber protecting member is provided for protecting the periphery of the optical fiber. An optical alignment of the optical fiber is carried out, and then the fixing member is fixed by laser welding.

FIG. 1 shows an example of a structure of a conventional optical device assembly. Typically, this assembly is housed in a package of the optical module in a later process to be formed into an optical module. The structure of the conventional optical device assembly, as shown in FIG. 1, includes a semiconductor laser 12 on a top surface of a base 10 via a submount 11. Also, a fixing member 13 is fixed to the base 10 to cover or stride over an optical fiber 14. The fixing member 13 is formed to curl or bent, for example, a stainless metal plate 13A, as shown in FIG. 2. FIG. 3A is a bottom view of the fixing member 13, which is made of a curled metal plate. FIG. 3B is a side view of the fixing member 13, when it is viewed from a direction of the optical fiber 14. FIG. 3C is a side view of the fixing member 13.

As shown in FIG. 3B, the fixing member 13 includes a holding portion 13₁, a connection portion 13₂, and a fixing portion 13₃. The holding portion 13₁ holds and fixes the optical fiber 14 on both sides. The connection portion 13₂ is a reverse U-shaped, and connects the holding portion 13₁ on both sides of the optical fiber. The fixing portion 13₃ fixes the fixing member 13 onto the base 10.

Welding (Laser welding) is employed for fixing the holding portion 13₁ and the fixing portion 13₃ respectively. In welding, weldable areas are limited to boundaries between the periphery (peripheral border) of the fixing member 13 and the portion to be welded. Specifically, the weldable areas are a boundary between the holding portion 13₁ and an optical fiver supporting portion 15 and that between the fixing portion 13₃ and the base 10. That is to say, the fixing member 13 and the portion to be welded are both exposed in the periphery of the fixing member 13. Accordingly, it is possible to weld the periphery of the fixing member 13 with a smaller power than welding through the fixing member 13. However, a large power is necessary for welding through the fixing member 13, and besides, the welding state cannot be confirmed from the outside. Also, welding sometimes damages the member itself. It is not suitable for manufacture that requires high reliability.

Japanese Patent Application Publication No. 7-333471 discloses a fiber fixing member in which a recess structure is formed for fixing the optical fiber.

The optical fiber 14 provided in the optical device assembly shown in FIG. 1 is aligned for the optimum optical coupling in advance, yet the fixing member 13 sometimes solidifies and contracts when welded, causing a misalignment in an optical axis. Also, the fixing portion 13₃ of the fixing member 13 is formed by folding the metal plate 13A into a complex shape as shown in FIG. 3B. There are some cases where the fixing portion 13₃ is not formed flatly on both sides of the optical fiber 14. As a result, the fixing member 13 is tilted when the fixing portion 13₃ is welded, causing a problem of the increased misalignment in the optical axis.

Here, with respect to the misalignment of the optical axis after welding, it can be considered that welding is further applied to another area to adjust the optical axis by use of the solidification and contraction. However, this adjustment welding is applied only to a limited weldable area. This results in a limitation of adjustable range of the light axis. After all, the adjustable amount is limited or no adjustment can be done.

Furthermore, the conventional fixing member 13 has a structure in which the connection portion 13₂ is provided to cover the optical fiber 14 as shown in FIG. 3B. In the process of positioning the optical fiber 14, in some cases, the optical fiber 14 is brought into contact with the connection portion 13₂. In this case, the optical fiber 14 lifts the connection portion 13₂. If the lift is a small amount in particular, welding is performed without realizing the raise of the fixing member 13. This causes a problem that stability after shipment degrades.

### SUMMARY OF THE INVENTION

The present invention has been made in view of the above circumstances and provides an optical fiber fixing portion in which a misalignment of an optical fiber can be readily adjusted to be highly reliable over a long period of time and an optical module having the same.

According to one aspect of the present invention, preferably, there is provided An optical fiber fixing member including: holding portions to sandwich an optical fiber from both sides thereof, which are formed by bending portions defined by incisions formed in a metal member; and a fixing portion to fix the optical fiber fixing member to a support member, which is defined by a remaining portion of the metal member except the holding portions.

According to another aspect of the present invention, preferably, there is provided and optical module including: an optical apparatus; an optical fiber fixing member having holding portions formed by bending portions defined by incisions formed in a metal member and a fixing portion defined by a remaining portion of the metal member except the holding portions, the holding portions sandwiching an optical fiber from both sides thereof, the fixing portion being used to attach the optical fiber fixing member to a support member; a base having the fixing portion of the optical fiber fixing member on a top surface thereof; and an optical fiber protecting portion that is held by the holding portions of the optical fiber fixing member and that includes the optical fiber inside thereof. Welding is performed between the base and the fixing portion of the optical fiber fixing member and between the optical fiber protecting portion and the holding portions of the optical fiber fixing member, in a state where a position of the optical fiber and that of the optical apparatus are aligned.

According to yet aspect of the present invention, preferably, there is provided a manufacturing method of an optical fiber fixing member including: forming bending portions by making incisions in a metal member; bending or curling the bending portions to form holding portions that sandwich an optical fiber from both sides; and forming a fixing portion defined by a remaining portion of the metal member except the bending portions and the holding portions.

According to further another aspect of the present invention, preferably, there is provided a manufacturing method of an optical module including: forming an optical fiber fixing member by making incisions in a metal member to form bending portions, forming holding portions by bending the bending portions to sandwich an optical fiber from both sides thereof, and forming a fixing portion by a remaining portion of the metal member except the bending portions and the holding portions; arranging an optical fiber protecting portion having an optical fiber therein to correspond to the holding portions of the optical fiber fixing member; aligning a light axis of the optical fiber with an optical apparatus; and welding between a base and the fixing portion of the optical fiber fixing member and between the optical fiber protecting portion and the holding portions of the optical fiber fixing member, in a state where a position of the optical fiber and that of the optical apparatus are aligned.

In accordance with the present invention, the incisions are provided to form the bending portions, and the holding portions are formed by folding the bending portions. It is therefore possible to fix the optical fiber stably with a simple configuration. The holding portions that hold the optical fiber have open ends, thereby enabling the optical fiber fixing portion to be lowered in height. In addition, the bending portions defined by the incisions provided in the metal member increase the peripheral border of the metal member, and this increases the weldable region. Accordingly, the misalignment of the optical fiber can be adjusted easily.

### BRIEF DESCRIPTION OF THE DRAWINGS

Preferred embodiments of the present invention will be described in detail with reference to the following drawings, wherein:

FIG. 1 shows an example of a structure of a conventional optical device assembly;

FIG. 2 is a view showing a configuration of a metal plate;

FIG. 3A is a bottom view of a conventional fixing member;

FIG. 3B is a side view of the fixing member, when it is viewed from a direction of an optical fiber;

FIG. 3C is a side view of the fixing member;

FIG. 4A through FIG. 4C are views showing a configuration of the fixing member;

FIG. 5A through FIG. 5C are views showing an example of a holding portion;

FIG. 6A through FIG. 6C are views showing another example of the holding portion;

FIG. 7A through FIG. 7C are views showing another example of the holding portion;

FIG. 8A through FIG. 8C are views showing another example of the holding portion;

FIG. 9A through FIG. 9C are views showing another example of the holding portion;

FIG. 10A through FIG. 10C are views showing another example of the holding portion;

FIG. 11A through FIG. 11C are views showing another example of the holding portion;

FIG. 12A through FIG. 12C are views showing another example of the holding portion;

FIG. 13A through FIG. 13C are views showing another example of the holding portion;

FIG. 14A through FIG. 14C are views showing another example of the holding portion;

FIG. 15 shows a configuration of an optical module; and

FIG. 16 is a flowchart of a manufacturing procedure of the optical module.

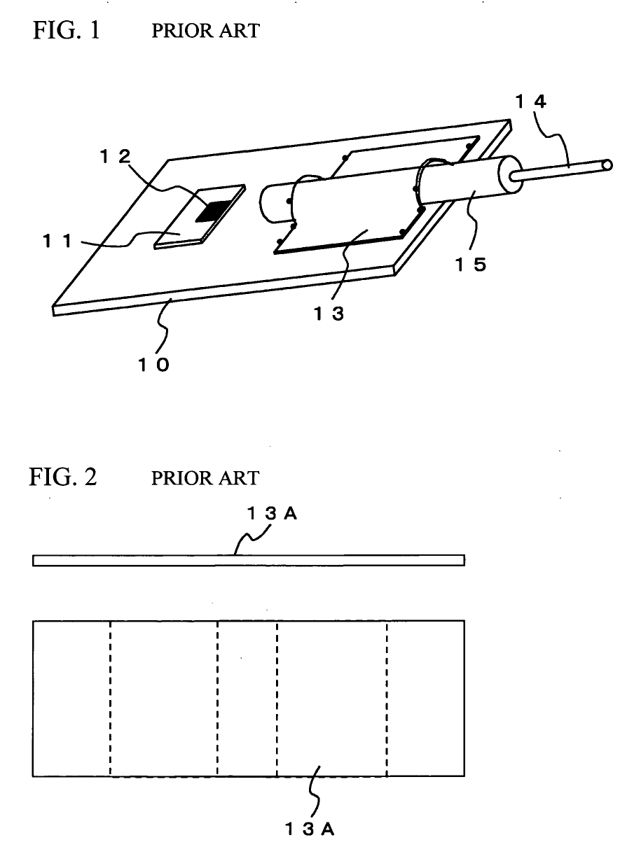

### DESCRIPTION OF THE PREFERRED EMBODIMENTS

A description will now be given, with reference to the accompanying drawings, of embodiments of the present invention.

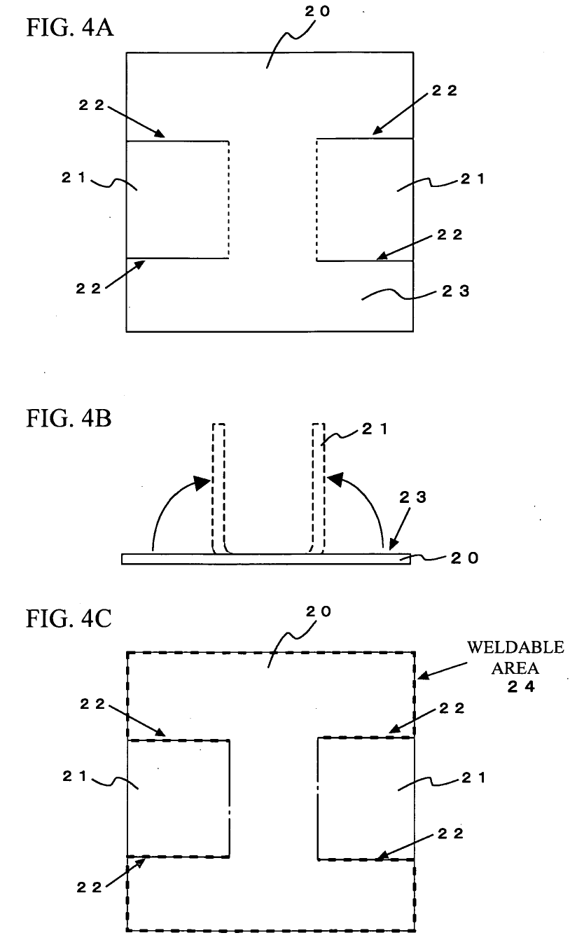

A fixing member in accordance with the present invention will be described with reference to FIG. 4A through FIG. 4C. Referring to FIG. 4A, in accordance with the present embodiment, incisions 22 are made on two sides that face each other in a metal plate 20 so as to form bending portions. Holding portions 21, which sandwich the optical fiber from both sides as shown in FIG. 4B, are formed by folding the bending portions indicated by dotted lines provided in parallel in an identical direction. An upper side of the region that holds the optical fiber is opened, as shown in FIG. 4B. Such opened shape does not cause the problem that the optical fiber lifts the fixing member during the alignment of the optical fiber. The metal plate 20 may be made of a stainless metal, for example.

The portion other than the holding portions 21 in the metal plate 20 serves as a fixing portion 23 that fixes the metal plate. The fixing portion 23 is not bent or curled for processing, and an originally provided plane shape of the metal plate 20 is maintained, enabling the optical fiber to be fixed stably.

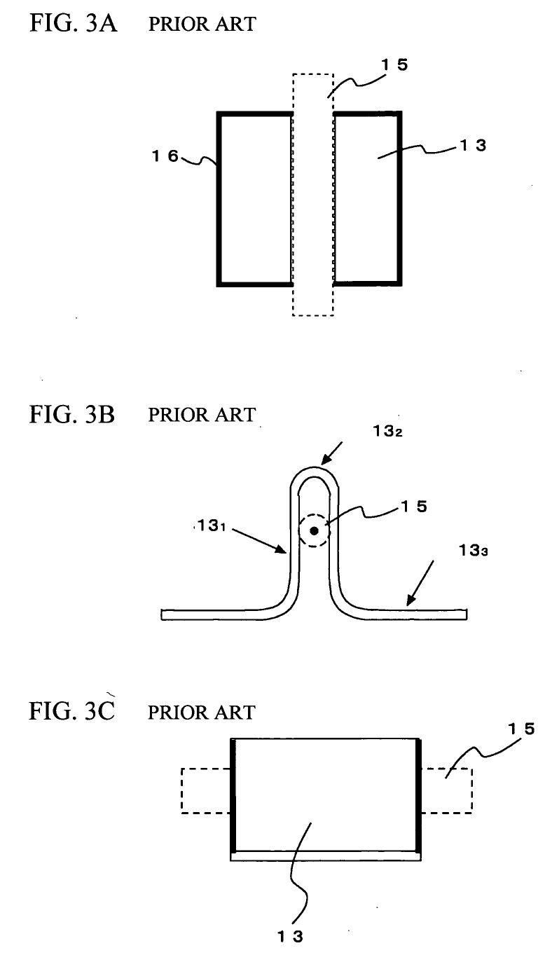

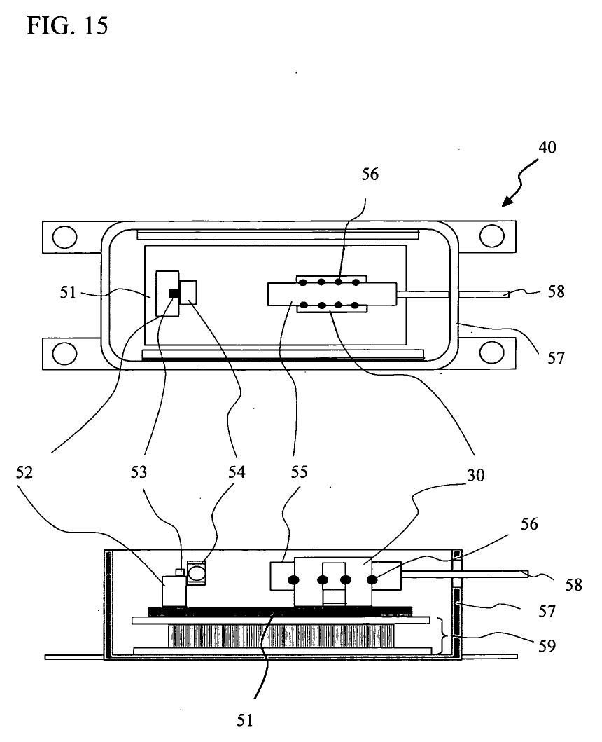

An optical fiber fixing member 30 having the above-described shape is fixed onto a base 51 shown in FIG. 15 by welding, yet it is possible to increase the weldable area in the fixing member 30 more than the conventional one. That is, as shown in FIG. 3A, the conventional fixing member has the weldable area only in the periphery (peripheral border) of the metal plate. However, in accordance with the present embodiment of the present invention, weldable areas 24 are provided not only in the periphery of the metal plate 20 but also in the incisions 22, which are formed for folding the holding portions 21. The weldable areas 24 are indicated by dotted lines in FIG. 4C. Accordingly, the adjustable and weldable area that is provided for adjusting the optical axis of the optical fiber becomes greater, making it possible to increase the adjustable amount of the light axis.

In FIG. 4B, the holding portions 21 are bent at a right angle to the fixing portion 23, yet the present invention is not limited to this angle. Also, the two holding portions 21 having similar sizes are formed to face each other, yet the areas of the holding portions should not necessarily be identical and the positions thereof may be out of alignment.

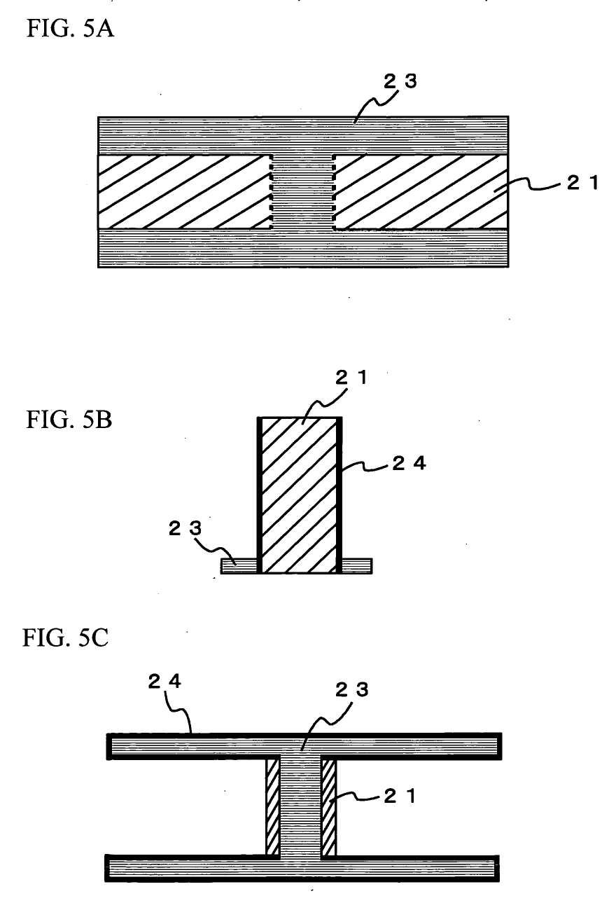

Next, the shape of the holding portion 21 is exemplarily described. FIG. 5A through FIG. 14C show configurations of the fixing member 30 having different shapes of the holding portions 21. In each drawing, FIG. 5A through FIG. 14A show top views before the holding portion 21 is folded. FIG. 5B through FIG. 14B show side views of the holding portion 21 after it is folded. FIG. 5C through FIG. 14C show top views of the holding portions 21 after they are folded.

In an example shown in FIG. 5A through FIG. 5C, linear incisions are made from the inside of the metal plate to extend to the periphery so as to form the holding portions 21. The holding portions 21 are formed by a cut process such as press cutting, for example. The holding portions 21 shown in FIG. 5A are folded in an identical direction.

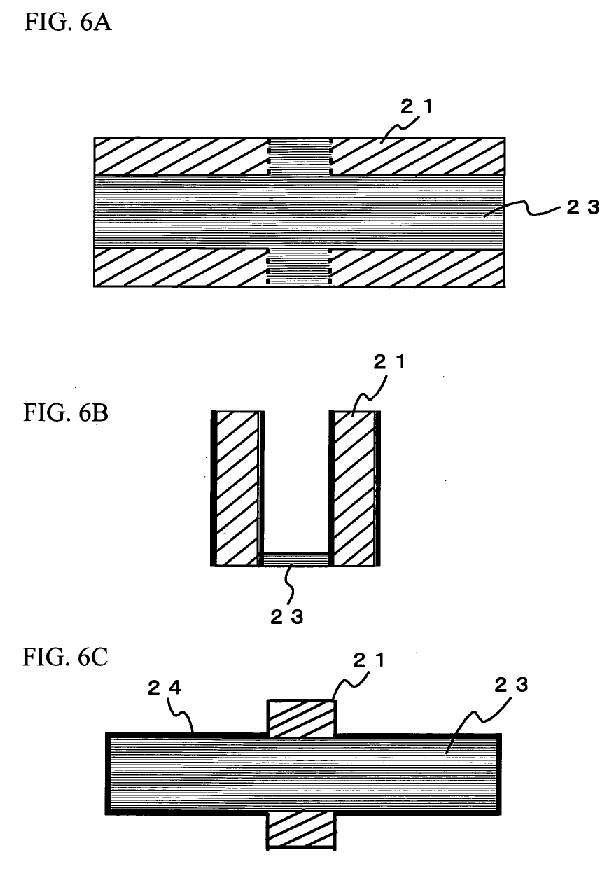

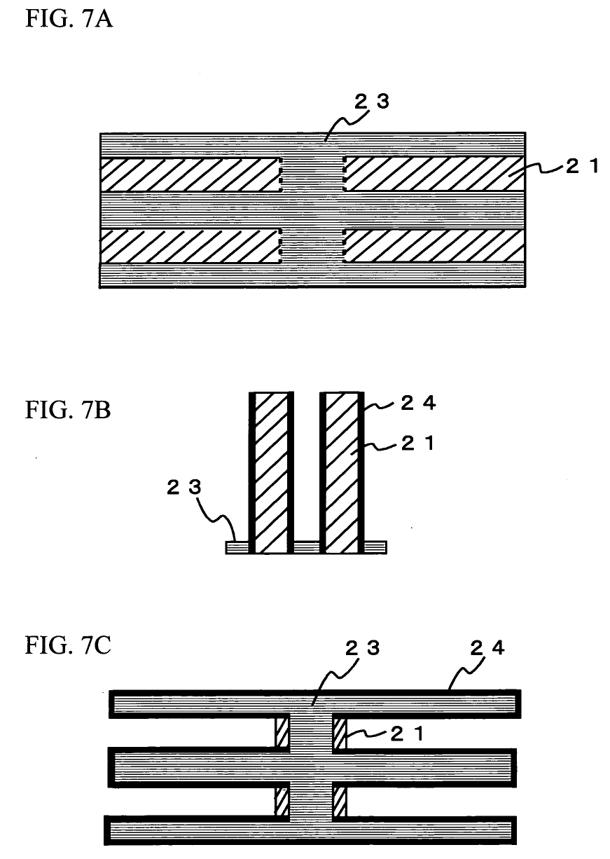

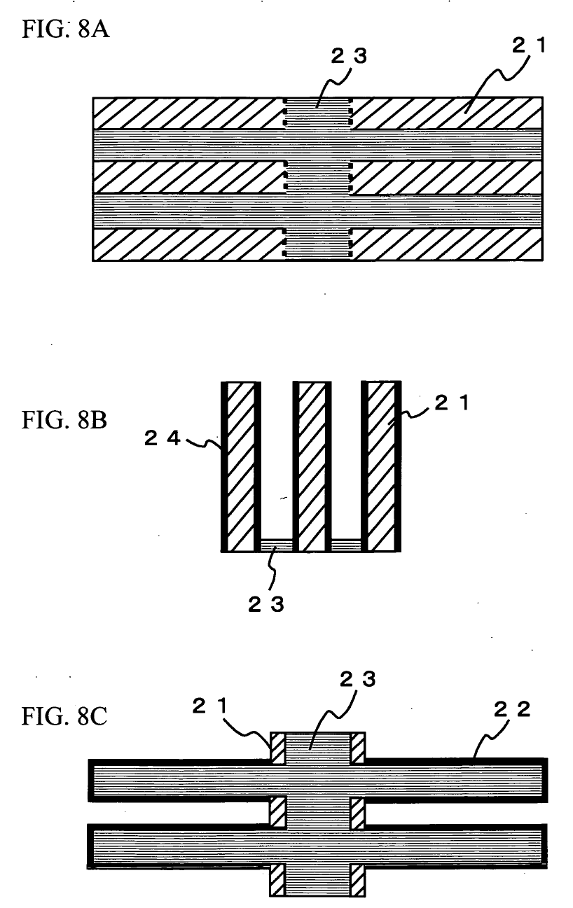

At this time, it is possible to select what section having an incision should serve as the holding portion 21, as necessary. As shown in FIG. 5A, two portions provided in the middle in the shorter side correspond to the holding portions 21. The holding portion 21 shown in FIG. 5A through FIG. 5C now serves as the fixing portion 23 in FIG. 6A through FIG. 6C, and a portion provided in the middle in the longer side also serves as the fixing portion 23. The fixing portion 23 except the afore-mentioned portion provided in the middle in the longer side in FIG. 5A through FIG. 5C now serves as the holding portions 21 in FIG. 6A through FIG. 6C. In any case, the effects of the present invention are equal. However, there is an advantage in stability in that the optical fiber can be welded at greater intervals. In consideration of this point, the farthest weldable points exist in the periphery of the metal plate. Therefore, as shown in FIG. 6A through FIG. 6C, preferably, the section that serves as the holding portion 21 is selected so that the periphery of the metal plate may be partially included in a side to be provided in a direction perpendicular to the fixing portion 23. The holding portions 21 can be realized by means of the press working with a mold. FIG. 7A through FIG. 8C show configurations having multiple holding portions 21 and multiple fixing portions 23. By increasing the number of the holding portions 21 and the number of the fixing portions 23, the weldable area can be further increased.

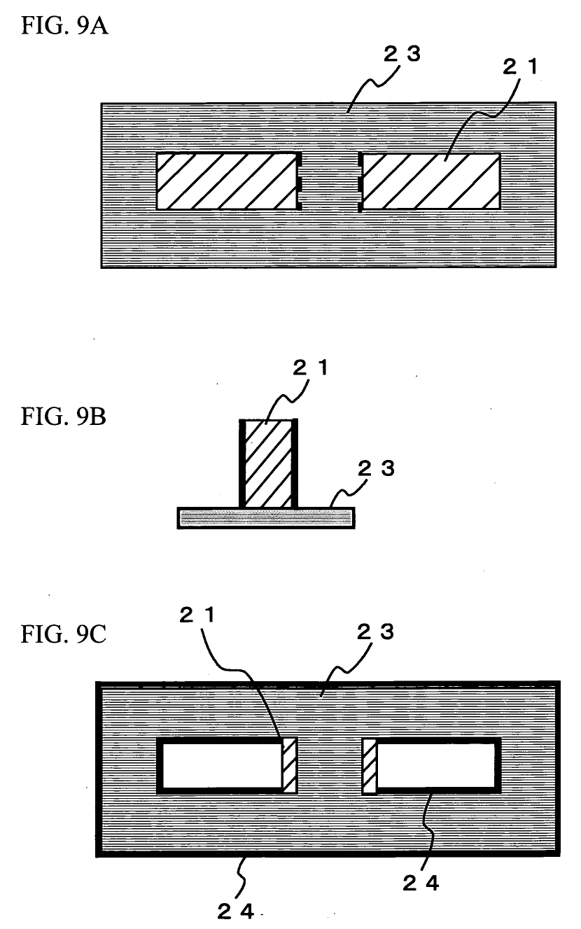

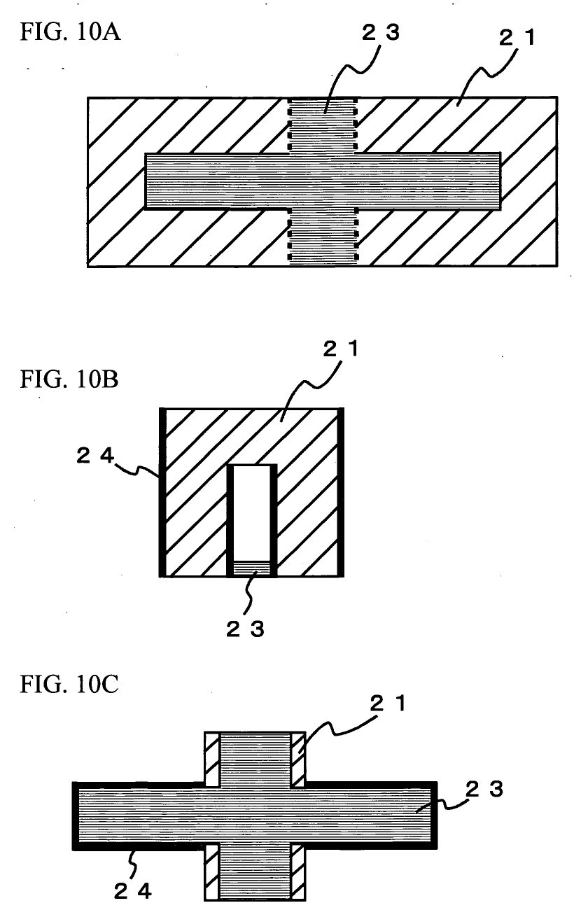

FIG. 9A through FIG. 9C show another configuration in which two cut out portions are provided inside the metal plate. The two cut our portions have similar sizes, and are laterally provided side by side, as shown in FIG. 9A. The holding portions 21 are formed in such a manner that the cut out portions do not extend to the periphery of the metal plate. The fixing portion 23, except the middle portion thereof in the longer side, is substantially lateral U-shaped, as shown in FIG. 9A. In contrast, the holding portion 21 shown in FIG. 9A through FIG. 9C now serves as the fixing portion 23 in FIG. 10A through FIG. 10C, and a portion provided in the middle in the longer side also serves as the fixing portion 23. The fixing portion 23 except the afore-mentioned portion provided in the middle in the longer side in FIG. 9A through FIG. 9C now serves as the holding portions 21 in FIG. 10A through FIG. 10C. In this manner, except the middle portion in the longer side, the holding portion 21 or the fixing portion 23 does not extend to the periphery of the metal plate, thereby enhancing the stability of the holding portion 21 or the fixing portion 23.

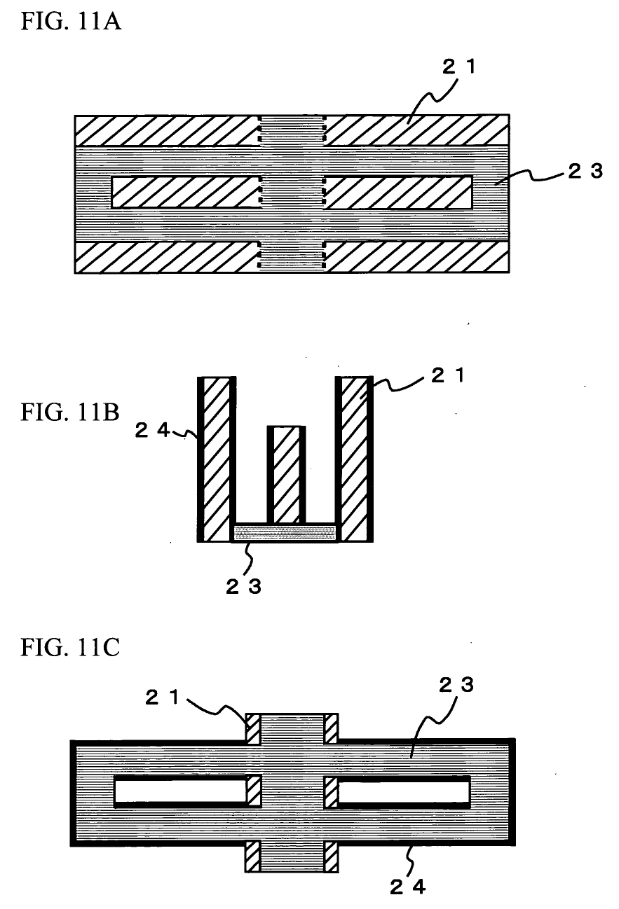

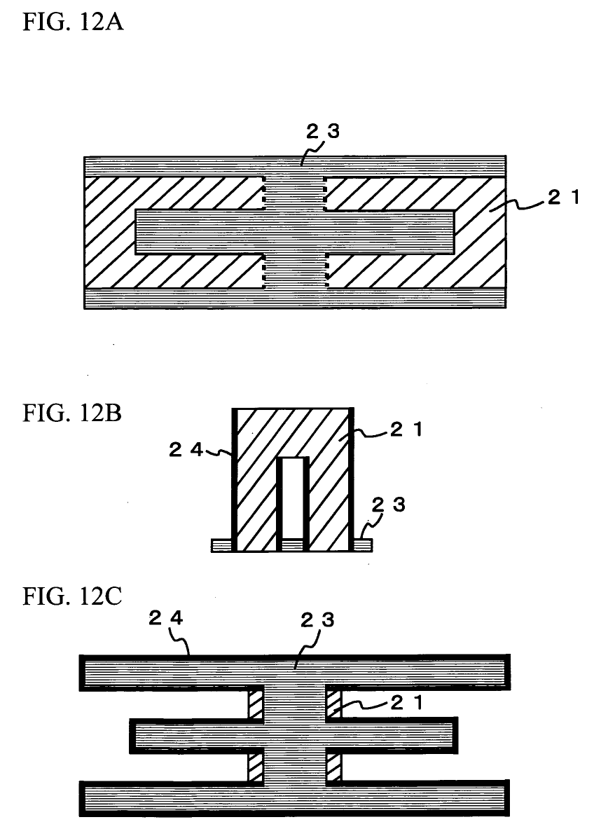

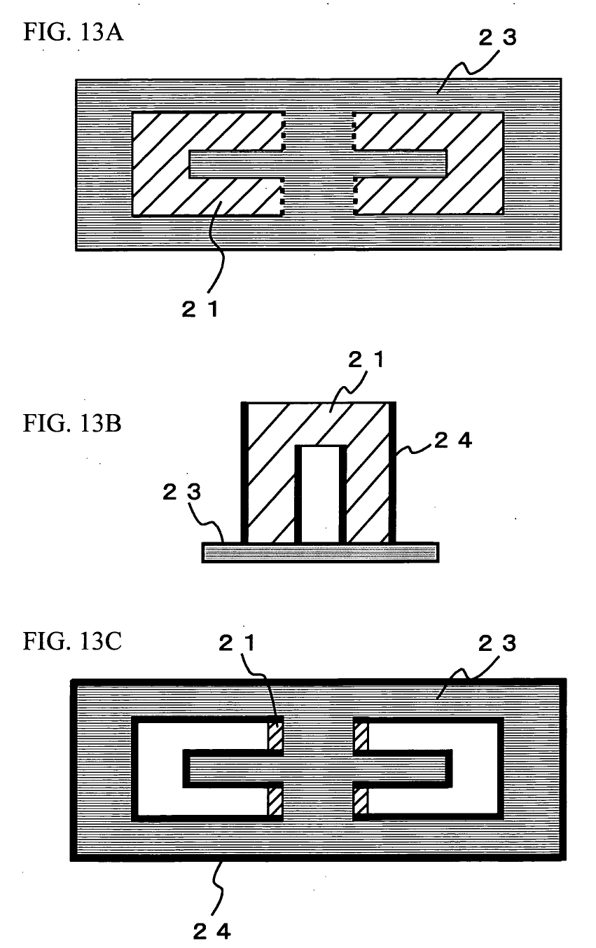

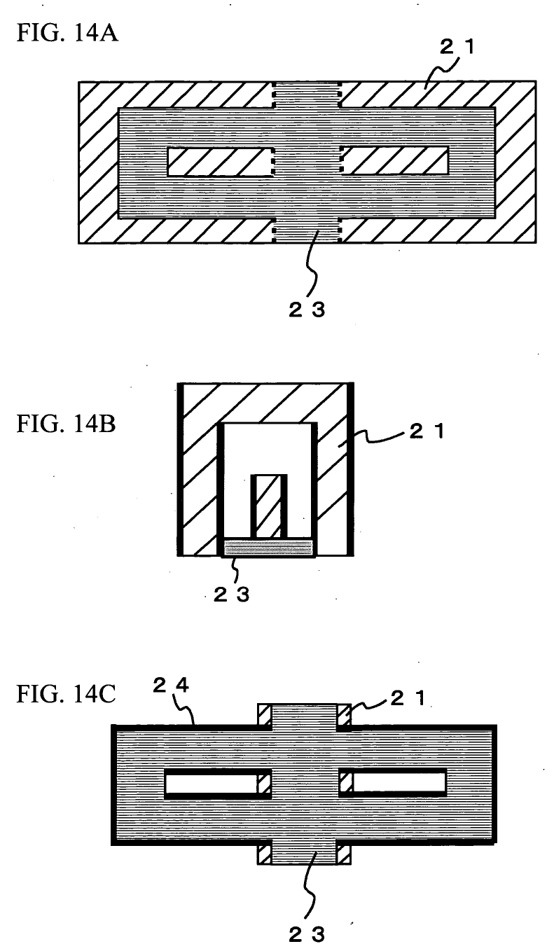

FIG. 11A through FIG. 11C show another configuration in which the cut out portions are provided and the incisions are made to extend to the periphery of the metal plate. As shown in FIG. 11B, ends of the holding portions 21 face upwardly, as if ends of a character E faced upwardly. FIG. 12A through FIG. 12C show another configuration in which the holding portions 21 and the fixing portion 23, except the middle portion in the longer side, shown in FIG. 11A through FIG. 11C are switched. As shown in FIG. 12B, the holding portion 21 is substantially downward U-shaped. FIG. 13A through FIG. 13C shows another configuration in which the two holding portions 21. As shown in FIG. 13A, the two holding portions 21 are substantially lateral U-shaped, are symmetrically provided with respect to the middle portion in the longer side, and the periphery of the metal plate 20 is occupied by the fixing portion 23. As shown in FIG. 13B, the holding portion 21 is substantially downward U-shaped. FIG. 14A through FIG. 14C show another configuration in which the holding portions 21 and the fixing portion 23, except the middle portion in the longer side shown in FIG. 13A through FIG. 13C, are switched. As shown in FIG. 14B, the holding portion 21 is so formed as if a substantially downward U-shaped form is extracted.

As shown in FIG. 6A through 6C, FIG. 7A through 7C, FIG. 8A through 8C, FIG. 11A through 11C, and FIG. 14A through 14C, the bending portions are respectively divided into multiple pieces at given intervals. Therefore, the weldable areas can be increased.

Referring now to FIG. 15, a description will be given of an optical module 40 having the fixing member 30 mounted thereon. The optical module 40 includes a submount 52, a semiconductor laser 53, a thermo module 59, a lens (lens folder) 54, the base 51, an optical fiber 58, an optical fiber protecting portion 55, the fixing member 30, and a module package 57.

As shown in FIG. 15, the semiconductor laser 53 is mounted on the submount 52, and the lens 54 that is held by the lens folder is provided on a side surface of the submount 52. The submount 52 is provided on the base 51. The fixing member 30 in accordance with the present invention is also provided on the base 51. In accordance with the present embodiment, the fixing member 30 having a shape shown in FIG. 10A through FIG. 10C is employed.

The optical fiber 58 is retained on the end thereof by the optical fiber protecting portion (ferrule) 55, and is optically aligned and fixed onto the base 51 with the fixing member 30 by welding. The base 51 is mounted on the thermo module 59 included in the module package 57.

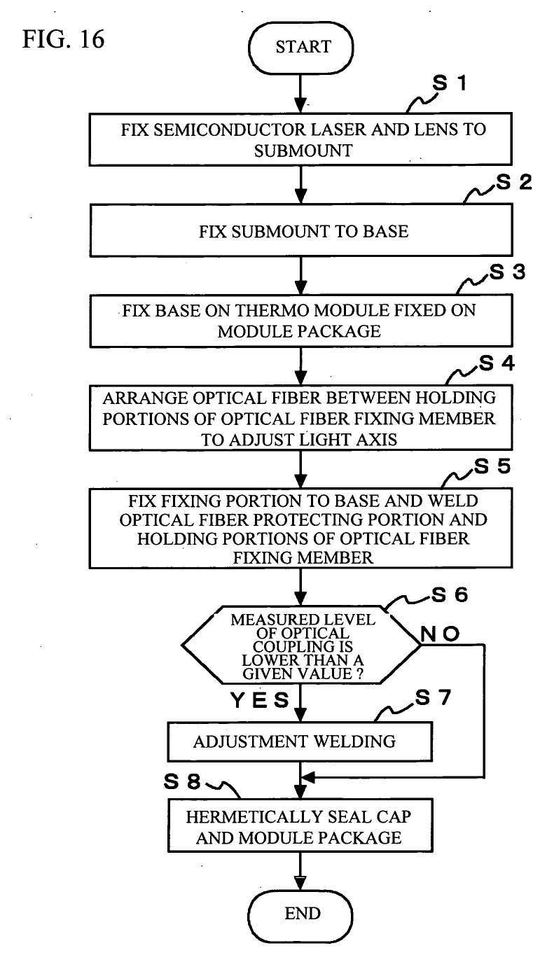

Next, referring now to FIG. 16, a description will be given of a manufacturing method of the optical module 40. First, the semiconductor laser 53 and the lens 54 are fixed onto the submount 52 (step S1). Then, the submount 52 is fixed onto the base 51 (step S2).

Subsequently, the base 51 is fixed onto the thermo module 59 fixed to the module package 57 (step S3). Here, the lens 54 fixed at step S1 may be fixed subsequent to the afore-mentioned process. Then, the fixing member 30 is provided. In this stage, the fixing member 30 is not welded.

Then, the optical fiber 58 is provided between the holding portions 21 of the fixing member 30. The semiconductor laser 53 is driven for outputting the laser beam so as to align the light axis of the laser beam and that of the optical fiber 58. The core of the optical fiber 58 is aligned in order to obtain a desired level in optical coupling (step S4). This core alignment is implemented by operating an alignment jig, not shown, which sandwiches the optical fiber protecting portion. The fixing member 30 in accordance with the present invention is opened on the upper portion of the holding portion 21. Accordingly, the fixing member 30 is not lifted or raised in the connection portion 13₂ in the core alignment process, as seen in the conventional fixing member 13.

Subsequent to the core alignment, the fixing portion 23 of the fixing member 30 is fixed onto the base 51 by the laser welding such as YAG laser, for example. Then, the optical fiber protecting portion 55 and the holding portions 21 of the fixing member 30 are fixed by welding in the same manner (step S5). Here, until the welding is completed, the optical fiber protecting portion 55 is fixed at a position after the core alignment is implemented by the alignment jig at step S4. The fixing member 30 in accordance with the present invention eliminates the problem that the fixing member 30 is fixed on a tilt in the welding process or the stability after welding is deteriorated. This is because the fixing portion 23 of the fixing member 30 is horizontally provided to the base 51.

Then, the alignment jig is removed, and the semiconductor laser is driven again to measure the level of the optical coupling. This is because the optical fiber 58 moves from the core alignment position in some cases in a later process, after the core alignment process is completed at step S4. The level of the optical coupling that has been measured is compared with a predetermined value. If such measured optical coupling is below the predetermined value (YES at step S6), the adjustment welding is implemented (step S7). Here, the adjustment welding denotes a method of realizing the desired adjustment of the light axis with the use of solidification and contraction of welding. In the adjustment welding, a welding point is formed by radiating the YAG laser or the like for adjustment, so that the desired level of the optical coupling may be realized as necessary, while the changing level of the optical coupling is being detected. The adjustment welding can be performed for either or both of the holding portion 21 and the fixing portion 23 of the fixing member 30. If such measured optical coupling is not below the predetermined value (NO at step S6), the process of the adjustment welding is omitted.

After the above-described process is completed, a cap, not shown, is provided for hermetically sealing the module package 57 (at step S8) to complete the semiconductor laser module.

As described heretofore, in accordance with the present embodiment, the holding portion 21, which is formed by making incisions in the metal plate 20, increases the weldable area in the fixing member 30, thereby increasing the weldable area that is applicable for the adjustment welding. It is therefore possible to increase the adjustment range of the light axis. In addition, the fixing portion 23 of the fixing member 30 can be maintained horizontally to the base 51. Thus, the displacement generated in the welding process of welding the fixing member 30 can be reduced, thereby making it possible to prevent the disturbance of the increased effects in the adjustment range of the light axis.

The fixing member 30 has the holding portion 21 having open ends, thereby enabling to reduce the height of the module. That is to say, if the fixing member 30 has the connection portion 13₂ like the conventional one, the connection portion 13₂, which is not to be welded, is positioned higher than the position of the optical fiber protecting portion 55. This increases the height of the module package 57, yet in accordance with the present invention, such connection portion is not provided, and thus, this problem can be solved.

Although the preferred embodiments have been described heretofore, the present invention is not limited to the above-mentioned embodiments, and other embodiments, variations and modifications may be made without departing from the scope of the present invention. For example, in accordance with the embodiment described above, the optical module having the semiconductor laser has been described, yet the present invention is applicable to the optical module having a light-receiving element.

The present invention is based on Japanese Patent Application No. 2005-104099 filed on Mar. 31, 2005, the entire disclosure of which is hereby incorporated by reference.

What is claimed is:

1. An optical fiber fixing member comprising:
holding portions to sandwich an optical fiber from both sides thereof, which are formed by bending portions defined by incisions formed in a metal member; and
a fixing portion to fix the optical fiber fixing member to a support member, which is defined by a remaining portion of the metal member except the holding portions.

2. The optical fiber fixing member as claimed in claim 1, wherein the metal member is divided at given intervals to form the holding portions.

3. The optical fiber fixing member as claimed in claim 1, wherein the holding portions are respectively formed to be substantially lateral U-shaped.

4. The optical fiber fixing member as claimed in claim 1, wherein the fixing portion is formed by a middle portion and two substantially lateral U-shaped that are symmetrically provided with respect to the middle portion.

5. The optical fiber fixing member as claimed in claim 1, wherein the fixing portion is the metal member that is not bent.

6. An optical module comprising:
an optical apparatus;
an optical fiber fixing member having holding portions formed by bending portions defined by incisions formed in a metal member and a fixing portion defined by a remaining portion of the metal member except the holding portions, the holding portions sandwiching an optical fiber from both sides thereof, the fixing portion being used to attach the optical fiber fixing member to a support member;
a base having the fixing portion of the optical fiber fixing member on a top surface thereof; and
an optical fiber protecting portion that is held by the holding portions of the optical fiber fixing member and that includes the optical fiber inside thereof,
wherein welding is performed between the base and the fixing portion of the optical fiber fixing member and between the optical fiber protecting portion and the holding portions of the optical fiber fixing member, in a state where a position of the optical fiber and that of the optical apparatus are aligned.

7. The optical module as claimed in claim 6, wherein an adjustment welding is performed to adjust an alignment of the optical fiber and the optical apparatus between the base and the fixing portion of the optical fiber fixing member or between the optical fiber protecting portion and the holding portions of the optical fiber fixing member.

8. The optical module as claimed in claim 7, wherein the welding or the adjustment welding is performed on a side formed by the incisions made in the optical fiber fixing member.

9. The optical module as claimed in claim 6, wherein the optical apparatus is a semiconductor laser or a light-receiving element.

10. A manufacturing method of an optical fiber fixing member comprising:
forming bending portions by making incisions in a metal member;
bending or curling the bending portions to form holding portions to sandwich an optical fiber from both sides; and
forming a fixing portion defined by a remaining portion of the metal member except the bending portions and the holding portions.

11. The manufacturing method as claimed in claim 10, wherein the incisions are provided for dividing the holding portions into multiple pieces.

12. The manufacturing method as claimed in claim 10, wherein the incisions are made to form the holding portions to be substantially lateral U-shaped.

13. The manufacturing method as claimed in claim 10, wherein the incisions are made to form the fixing portion to be substantially lateral U-shaped.

14. A manufacturing method of an optical module comprising:
forming an optical fiber fixing member by making incisions in a metal member to form bending portions, forming holding portions by bending the bending portions to sandwich an optical fiber from both sides thereof, and forming a fixing portion by a remaining portion of the metal member except the bending portions and the holding portions;
arranging an optical fiber protecting portion having an optical fiber therein to correspond to the holding portions of the optical fiber fixing member;
aligning a light axis of the optical fiber with an optical apparatus; and
welding between a base and the fixing portion of the optical fiber fixing member and between the optical fiber protecting portion and the holding portions of the optical fiber fixing member, in a state where a position of the optical fiber and that of the optical apparatus are aligned.

15. The manufacturing method as claimed in claim 14, further comprising a step of performing an adjustment welding, subsequent to the step of welding, to adjust an alignment of the optical fiber and the optical apparatus between the base and the fixing portion of the optical fiber fixing member or between the optical fiber protecting portion and the holding portions of the optical fiber fixing member.

16. The manufacturing method as claimed in claim 15, wherein the optical fiber protecting portion is held by an alignment jig, and the optical fiber protecting portion is released after the step of welding and before the step of performing the adjustment welding.

17. The manufacturing method as claimed in claim 14, the step of welding or the step of performing the adjustment welding is performed by laser welding.
